(19) United States
(12) Patent Application Publication
(10) Pub. No.: US 2023/0126316 A1
(43) Pub. Date: Apr. 27, 2023

(54) SPEAKER SYSTEM FOR PERSONAL TRANSPORTATION VEHICLES

(71) Applicant: Jetson Electric Bike LLC, Brooklyn, NY (US)

(72) Inventors: Josh Sultan, Brooklyn, NY (US); Sam Husain, Brooklyn, NY (US)

(21) Appl. No.: 17/510,503

(22) Filed: Oct. 26, 2021

(51) Int. Cl. B62J 45/10; H04R 1/02

(52) U.S. Cl. CPC B62J 45/10; H04R 1/023; H04R 1/026; H04R 1/028; H04R 2420/07; H04R 2201/025

(57) ABSTRACT

A personal transportation vehicle comprising a frame member including an aperture. The personal transportation vehicle further comprising a wireless speaker assembly configured within the frame member, wherein the wireless speaker assembly includes speakers and a protective grille that fits within the aperture. The personal transportation vehicle further comprising circuitry connected to the wireless speaker assembly that provides wireless speaker functionality with a mobile device, at least one wheel assembly, and a power source supplying power to the wireless speaker assembly.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to a speaker system, and in particular, wireless speakers that are integrated into personal transportation vehicles.

### Description of the Related Art

Wireless speakers are known which connect to user devices such as phones or laptops. Wireless speakers are used in varied indoor and outdoor environments including camping, hiking, climbing, travel, leisure, beach, boating, etc. However, such wireless speakers are typically not capable of efficiently interfacing with personal transportation vehicles, such as bicycles or scooters, and are often unable to recharge when away from an electrical outlet. Additionally, personal transportation vehicles do not typically have audible warning devices for alerting pedestrians or traffic. There is thus a need for a portable wireless speaker system that is particularly adapted to seamlessly interface with personal transportation vehicles to enhance the overall user experience when riding such vehicles.

### SUMMARY OF THE INVENTION

A personal transportation vehicle comprising a frame member including an aperture. The personal transportation vehicle further comprises a wireless speaker assembly configured within the frame member, wherein the wireless speaker assembly includes speakers and a protective grille that fits within the aperture. The personal transportation vehicle further comprises circuitry connected to the wireless speaker assembly that provides wireless speaker functionality with a mobile device, at least one wheel assembly, and a power source supplying power to the wireless speaker assembly.

The personal transportation vehicle may further comprise a wireless speaker mount attached to a base on a handle bar. The speakers and the protective grille may be mounted to the wireless speaker mount. The frame member is removably attached to a handle bar and a platform. The frame member may comprise a stem coupled between the handle bar and the platform. The power source may comprise a rechargeable battery or a non-rechargeable battery that is removable from the platform.

The circuitry may include a wireless receiver, an audio processor, an amplifier, and an audio output module. The wireless receiver may support connectivity of at least one of Bluetooth, Wi-Fi, ZigBee, near-field communication, or cellular data. The wireless speaker circuitry may enable the mobile device to play music, play audio navigation, or perform hands-free phone calling. The wireless speaker circuitry may also enable the mobile device to play an alarm, horn, or warning.

The protective grille may comprise a hard or soft material mounted over a face of the speakers. The protective grille may include an air and/or water tight seal that fits to the aperture of the frame member. The personal transportation vehicle may further comprise a control panel that controls operation of the wireless speaker assembly and circuitry. In one embodiment, the personal transportation vehicle may comprise a platform coupled to the at least one wheel assembly, wherein the platform includes the power source. In another embodiment, the personal transportation vehicle may further comprise a generator coupled to the power source, wherein the generator supplies electrical current to the power source.

According to another aspect, the present invention provides a personal transportation vehicle frame. The personal transportation vehicle frame comprises a frame component including a cavity, a wireless speaker unit including a loudspeaker and a wireless receiver, and a battery housing coupled to the wireless speaker unit and inserted with the wireless speaker unit into the cavity, wherein the battery housing includes a battery tray storing a power source that supplies power to the wireless speaker unit and a battery housing cap that secures the battery housing to an opening of the cavity.

The wireless speaker unit may support connectivity of at least one of Bluetooth, Wi-Fi, ZigBee, near-field communication, or cellular data. The wireless speaker unit may enable the mobile device to play music, play audio navigation, or perform hands-free phone calling. The frame component may further comprise a protective grille that protects the wireless speaker unit and battery housing. The protective grille may comprise a hard or soft material mounted directly over an aperture on the frame component.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a scooter according to an embodiment of the present invention.

FIGS. 2 through 4 illustrate a wireless speaker assembly according to an embodiment of the present invention.

FIG. 5 illustrates a personal transportation vehicle frame according to another embodiment of the present invention.

FIG. 6 illustrates a wireless speaker unit coupled to a battery housing according to an embodiment of the present invention.

FIGS. 7 and 8 illustrate a personal transportation vehicle frame configured with a wireless speaker unit according to an embodiment of the present invention.

FIG. 9 illustrates a bicycle according to an embodiment of the present invention.

FIG. 10 illustrates a close-up view of a speaker portion of the bicycle according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. The following detailed description is, therefore, not intended to be taken in a limiting sense.

The present application discloses a speaker system for wireless communication use with personal transportation vehicles, such as bicycles, scooters, and the like. The disclosed speaker system may enable a mobile device, such as a smart phone or tablet to connect to the speaker system to play content (e.g., music, audio navigation) or perform hands-free phone calls. According to another embodiment, the disclosed speaker system may be configured with a mobile device to play loud warnings that serve as a safety alarm or warning to people or vehicles around them.

According to one embodiment, a personal transportation vehicle may be operated by a rechargeable battery and includes an integrated wireless speaker that is powered by the rechargeable battery. The rechargeable battery may be charged by a generator on the personal transportation vehicle or by connection to a standard power outlet. The generator may be operable by a rotatable member of the personal transportation vehicle, such as a wheel or pedals, and which supplies electrical current when the rotatable member is rotated. The wireless speaker may be installed within the frame of the personal transportation vehicle, along with a power source (e.g., battery pack).

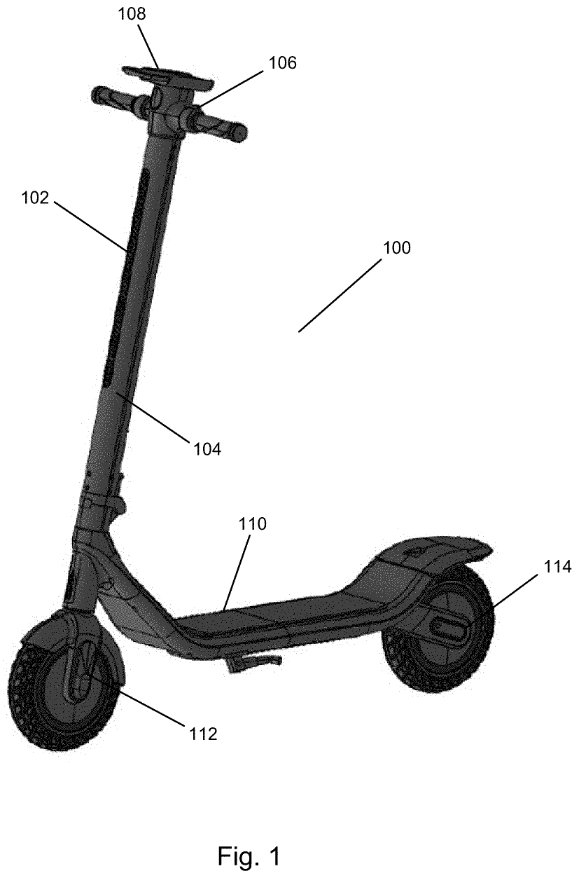

FIG. 1 illustrates a scooter according to an embodiment of the present invention. A scooter 100 comprises a stem 104, a handle bar 106, a device mount 108, a platform 110, a front wheel assembly 112, and a rear wheel assembly 114. A top end of stem 104 is coupled to the handle bar 106. The device mount 108 is configured above the handle bar 106. Device mount 108 is operable to hold or secure items, accessories, or a mobile device. A bottom end of stem 104 is coupled to the platform 110 such that the stem 104 is configured between the handle bar 106 and the platform 110. The front wheel assembly 112 and the rear wheel assembly 114 are attached to front and rear sections of an underside of platform 110, respectively.

The stem 104 comprises a sheath frame member covering a wireless speaker assembly 102 within a cavity of the sheath frame member. The sheath frame member may include an opening or aperture for wireless speaker assembly 102. The sheath frame member may be removably attached to handle bar 106 and/or platform 110. The platform 110 may include a power source comprising a rechargeable battery or a non-rechargeable battery that may be removable from the platform 110 for replacement. The power source may be charged by an electrical connection from platform 110 to a standard power outlet. The power source may supply power to a motor coupled to one or both of front wheel assembly 112 and rear wheel assembly 114. The power source may also supply power to the wireless speaker assembly 102 and circuitry associated thereof.

The scooter 100 may further comprise wireless speaker circuitry (not illustrated) connected to wireless speaker assembly 102 that provides wireless speaker functionality with a mobile device. The wireless speaker circuitry may be embedded within other frame portions of scooter 100, such as in the handle bar 106, device mount 108, or the platform 110. The wireless speaker circuitry may include a wireless receiver, an audio processor, an amplifier, and an audio output module coupled to an output terminal of the audio processor. The wireless speaker circuitry may support Bluetooth connectivity in addition to support of other wireless communications protocols or standards, such as Wi-Fi, ZigBee, near-field communication, cellular data, or any other open or proprietary wireless communications protocol. The wireless receiver may include hardware and/or software to receive a wireless signal from a mobile device and to decode a digital signal contained therein to extract an audio signal therefrom. The wireless speaker circuitry enables a mobile device, such as a smart phone or tablet to connect to the wireless receiver and play content (e.g., music, audio navigation, alarm, horn, or warning) or perform hands-free phone calls via wireless speaker assembly 102.

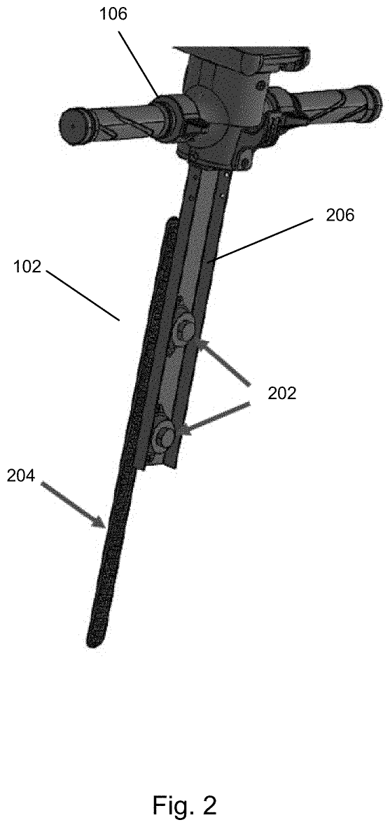

FIG. 2 presents an exposed view of the wireless speaker assembly according to an embodiment of the present invention. The wireless speaker assembly 102 may be embedded within a cavity of stem 104. The wireless speaker assembly 102 includes speakers 202 and protective grille 204 that are mounted to a wireless speaker mount 206. Speakers 202 may comprise loudspeakers that are secured to a rear facing side of the wireless speaker mount 206. Wireless speaker mount 206 is attached to the base of handle bar 106. Protective grille 204 may comprise either a hard or soft material mounted directly over the face of the speakers 202 on a front facing side of wireless speaker mount 206. The protective grille 204 may serve to protect the speakers 202 (and possibly other audio components) from foreign objects while still allowing sound to clearly pass. The protective grille 204 may further include a seal for fitting with the opening or aperture of the sheath frame member such that an air and/or water tight seal is formed.

The speakers 202 may be coupled to the wireless speaker circuitry for reproducing sounds in accordance with an audio signal contained within a digital signal received by the wireless receiver. The wireless capability of the speakers 202 to receive data over short distances from mobile devices facilitates convenient use for the operator of the scooter 100. As individuals have become increasingly reliant on mobile devices or wearable technology for audio content (e.g., music, podcasts, audio books, etc.), connectivity from relied upon mobile devices or wearable technology to the scooter 100 would add to an operator's experience. Mobile devices may comprise computing devices (e.g., cellular phones, smartphones, tablet computers, portable media players, e-book readers, smart watches and smart wearable devices, or any computing device having a central processing unit and memory unit capable of connecting to a network). Mobile devices may also include or execute an application to communicate content, such as, for example, textual content, multimedia content, or the like. The mobile devices may also include or execute an application to perform a variety of possible tasks, such as browsing, searching, playing various forms of content, including locally stored or streamed multimedia.

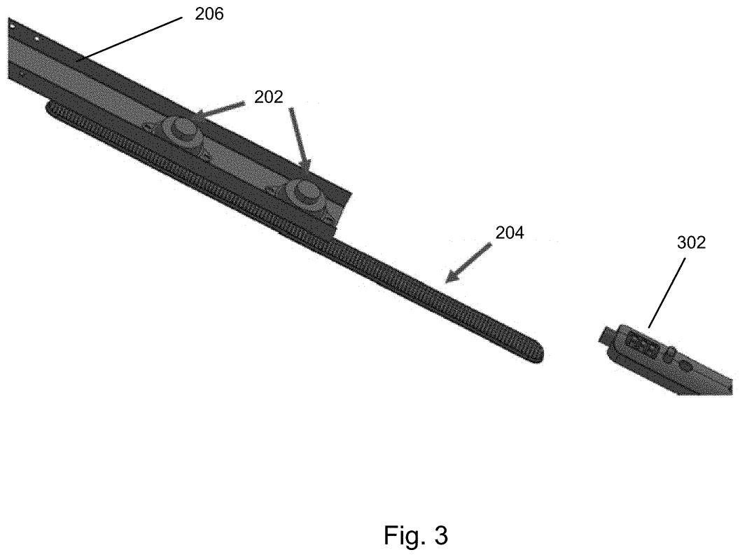

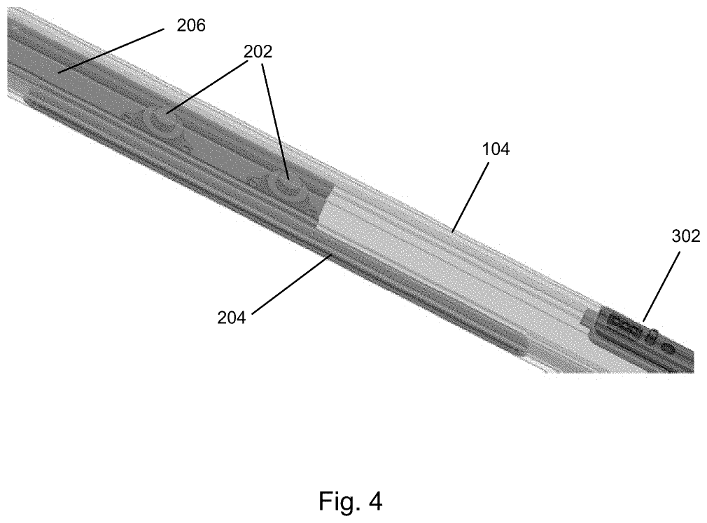

Referring to FIG. 3, stem 104 may further include a control panel 302 for powering on/off components (e.g., motor, wireless speaker assembly, and circuitry) of the scooter 100 as well as configuring operation of the components. FIG. 4 presents a partially transparent view of a stem of a personal transportation vehicle according to an embodiment of the present invention. Speakers 202 and wireless speaker mount 206 are encapsulated within a frame of the stem 104 while protective grille 204 is exposed through the opening or aperture of the stem 104. The opening or aperture may be located at a forward facing position of scooter 100, although other positions and configuration are possible. Control panel 302 may be installed on stem 104 in a backward facing position of scooter 100 such that the control panel 302 is facing the operator when standing behind the stem 104 or when riding on platform 110.

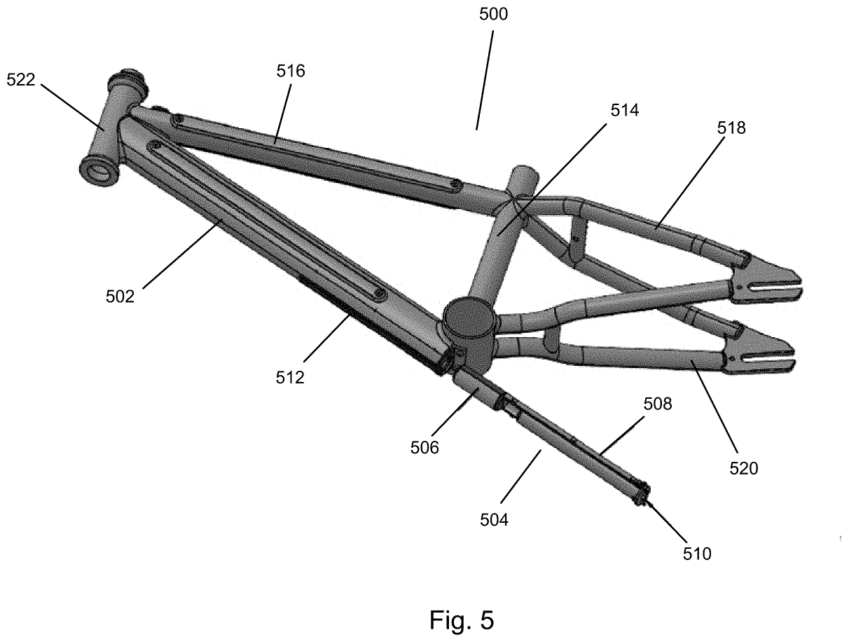

FIG. 5 presents a personal transportation vehicle frame according to an embodiment of the present invention. A personal transportation vehicle frame 500 comprises a bicycle frame including a bottom tube 502, a seat tube 514, a top tube 516, a seat stay 518, a chain stay 520, and a head tube 522. Certain frame components of the personal transportation vehicle frame 500 may include a cavity suitable for insertion with a wireless speaker unit 506 coupled to a battery housing 504. Such frame components may include the bottom tube 502, the seat tube 514, the top tube 516, and the head tube 522.

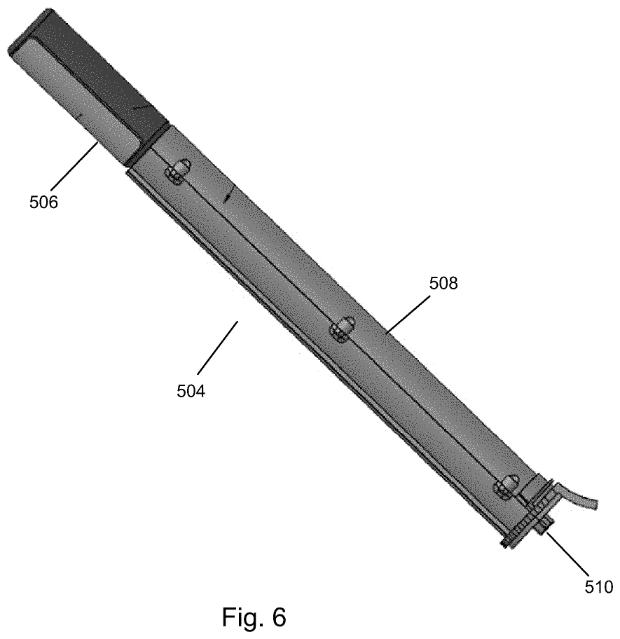

FIG. 6 presents a wireless speaker unit coupled to a battery housing according to an embodiment of the present invention. The wireless speaker unit 506 comprises components and functionality that are identical or similar to the wireless speaker circuitry disclosed above. The wireless speaker unit 506 may include one or more loudspeakers, a wireless receiver, an audio processor, an amplifier, and an audio output module coupled to an output terminal of the audio processor. The wireless speaker unit 506 may also include a fastener or threading for coupling to a battery housing 504. Battery housing 504 includes a battery tray 508 and a battery housing cap 510. A power source (e.g., a rechargeable or non-rechargeable battery) may be inserted into the battery tray 508 to supply power to the wireless speaker unit 506 from the battery housing 504. The power source can be charged by an electrical connection from battery housing 504 to a standard power outlet. Alternatively, the power source may be coupled to and charged by a generator (not illustrated) installed on the personal transportation vehicle. The generator may be operable by a rotatable member of the personal transportation vehicle, such as a wheel or pedals, and which supplies electrical current to the power source when the rotatable member is rotated.

The wireless speaker unit 506 may support Bluetooth connectivity in addition to support of other wireless communications protocols or standards, such as Wi-Fi, ZigBee, near-field communication, cellular data, or any other open or proprietary wireless communications protocol. The wireless receiver may include hardware and/or software to receive a wireless signal and to decode a digital signal contained therein to extract an audio signal therefrom. The wireless speaker unit 506 enables a mobile device, such as a smart phone or tablet to connect to the wireless receiver and play content (e.g., music, audio navigation) or perform hands-free phone calls via the wireless speaker unit 506.

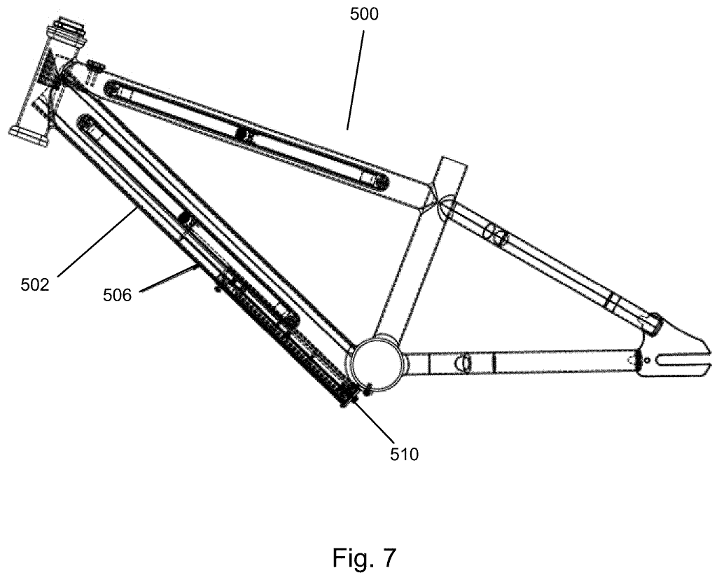

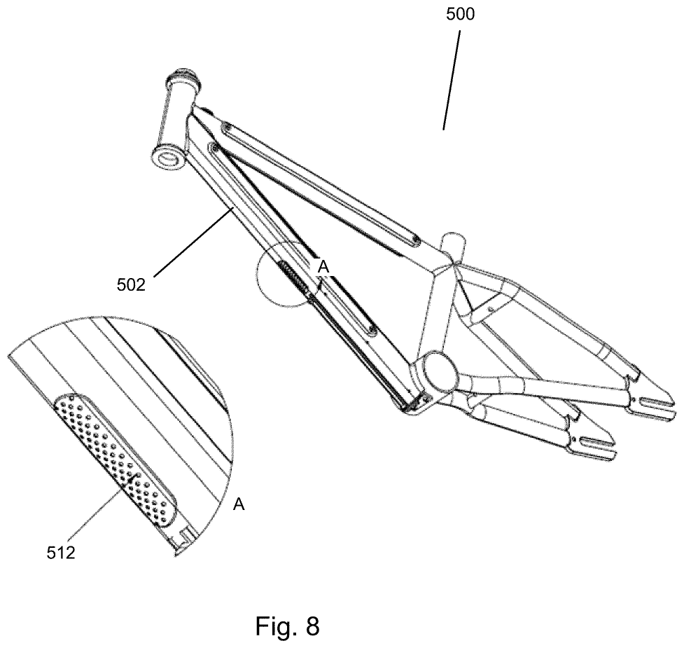

According to one embodiment, the wireless speaker unit 506 and the battery housing 504 can be inserted into an opening at bottom tube 502, as illustrated in FIG. 7. The battery housing 504 may be secured to the bottom tube 502 by screwing the battery housing cap 510 to the opening. The battery housing 504 may be removed from the bottom tube 502 by twisting and pulling the battery housing cap 510. Bottom tube 502 (or any frame component of the personal transportation vehicle frame 500 including a cavity suitable for insertion with wireless speaker unit 506 and battery housing 504) may include a protective grille 512 that protects the wireless speaker unit 506 and battery housing 504 from foreign objects while still allowing sound from the wireless speaker unit 506 to clearly pass, as shown in FIG. 8. The protective grille 512 may comprise either a hard or soft material mounted directly over an aperture on bottom tube 502 (or any frame component).

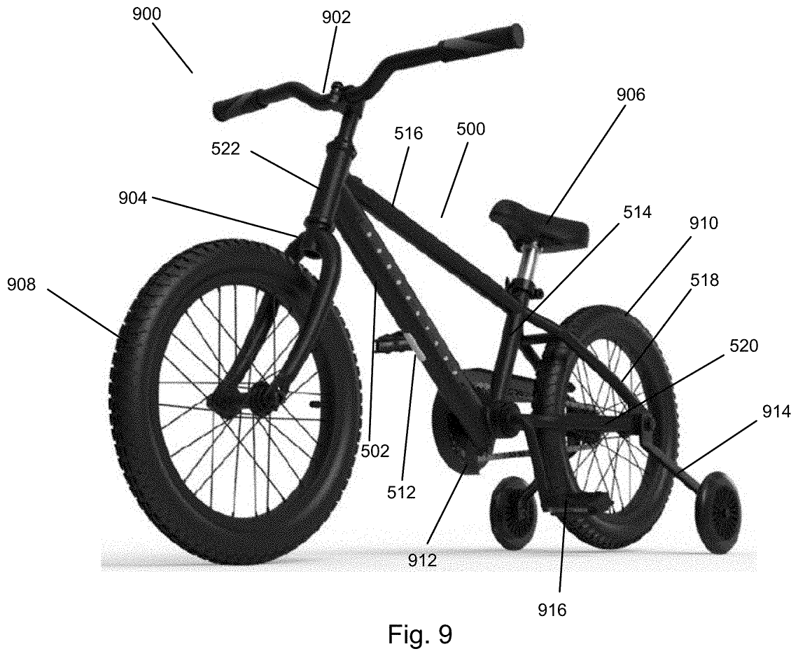

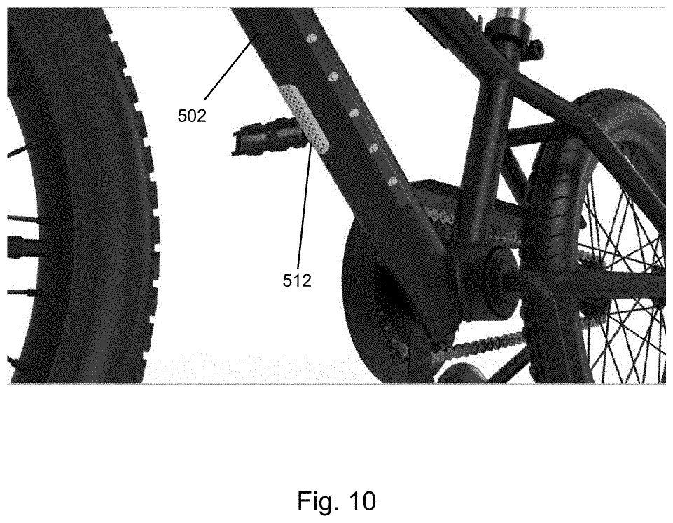

FIG. 9 presents a bicycle according to an embodiment of the present invention. A bicycle 900 comprises handle bar 902, fork 904, seat post 906, front wheel 908, rear wheel 910, groupset 912, training wheels 914, and pedal 916 that are coupled to personal transportation vehicle frame 500. FIG. 10 presents a close-up view of a speaker portion of the bicycle according to an embodiment of the present invention. Protective grille 512 provides a sound outlet for a wireless speaker unit and is positioned in a bottom-facing portion of the bottom tube 502. The protective grille protects a wireless speaker unit and battery housing within from foreign objects. The protective grille 512 is not limited to the bottom-facing portion and may be positioned in other positions and orientations.

FIGS. 1 through 10 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

1. A personal transportation vehicle comprising:
a handle bar;
a frame member removably attached to the handle bar, the frame member including an aperture;
a wireless speaker mount configured for insertion into the frame member;
a wireless speaker assembly mounted to the wireless speaker mount and configured for insertion within the frame member based at least in part on the insertion of the wireless speaker mount into the frame member, the wireless speaker assembly including speakers and a protective grille that fits within the aperture based at least in part on the insertion of the wireless speaker mount into the frame member;
circuitry connected to the wireless speaker assembly that provides wireless speaker functionality with a mobile device;
at least one wheel assembly, the frame member being disposed between the handle bar and the at least one wheel assembly; and
a power source supplying power to the wireless speaker assembly.

2. The personal transportation vehicle of claim 1 wherein the wireless speaker mount is attached to a base on the handle bar.

3. (canceled)

4. The personal transportation vehicle of claim 1 wherein the frame member is removably attached to a platform.

5. The personal transportation vehicle of claim 4 wherein the frame member comprises a stem coupled between the handle bar and the platform.

6. The personal transportation vehicle of claim 4 wherein the power source comprises a rechargeable battery or a non-rechargeable battery that is removable from the platform.

7. The personal transportation vehicle of claim 1 wherein the circuitry includes a wireless receiver, an audio processor, an amplifier, and an audio output module.

8. The personal transportation vehicle of claim 7 wherein the wireless receiver supports connectivity of at least one of Bluetooth, Wi-Fi, ZigBee, near-field communication, or cellular data.

9. The personal transportation vehicle of claim 1 wherein the wireless speaker circuitry enables the mobile device to play music, play audio navigation, or perform hands-free phone calling.

10. The personal transportation vehicle of claim 1 wherein the wireless speaker circuitry enables the mobile device to play an alarm, horn, or warning.

11. The personal transportation vehicle of claim 1 wherein the protective grille comprises a hard or soft material mounted over a face of the speakers.

12. The personal transportation vehicle of claim 1 wherein the protective grille includes an air and/or water tight seal that fits to the aperture of the frame member.

13. The personal transportation vehicle of claim 1 further comprising a control panel attached to the frame member that controls operation of the wireless speaker assembly and circuitry.

14. The personal transportation vehicle of claim 1 further comprising a platform coupled to the at least one wheel assembly, the platform including the power source.

15. The personal transportation vehicle of claim 1 further comprising a generator coupled to the power source, the generator supplying electrical current to the power source.

16. A personal transportation vehicle frame comprising:
a frame component removably attached to a handle bar, the frame component including a cavity;
a wireless speaker unit including a loudspeaker and a wireless receiver; and
a battery housing coupled to the wireless speaker unit such that the battery housing and the wireless speaker unit are configured for removable insertion into the cavity together, the battery housing including a battery tray storing a power source that supplies power to the wireless speaker unit and a battery housing cap that is configured to removably secure the battery housing to an opening of the cavity.

17. The personal transportation vehicle frame of claim 16 wherein the wireless speaker unit supports connectivity of at least one of Bluetooth, Wi-Fi, ZigBee, near-field communication, or cellular data.

18. The personal transportation vehicle of claim 16 wherein the wireless speaker unit enables the mobile device to play music, play audio navigation, or perform hands-free phone calling.

19. The personal transportation vehicle of claim 16 wherein the frame component further comprises a protective grille that protects the wireless speaker unit and battery housing.

20. The personal transportation vehicle of claim 19 wherein the protective grille comprises a hard or soft material mounted directly over an aperture on the frame component.

21. The personal transportation vehicle of claim 2 wherein the wireless speaker mount is configured for insertion into the frame member based at least in part on the attachment of the handle bar to the frame member.
